(19) United States
(12) Patent Application Publication
(10) Pub. No.: US 2012/0038936 A1
(43) Pub. Date: Feb. 16, 2012

(54) Measurement System Using Alignment Unit And Position Measuring Method

(75) Inventors: Sung Min Ahn, Suwon-si (KR); Sang Don Jang, Suwon-si (KR); Tae Kyu Son, Seongnam-si (KR)

(73) Assignee: SAMSUNG ELECTRONICS CO., LTD., Suwon-si (KR)

(21) Appl. No.: 13/185,047

(22) Filed: Jul. 18, 2011

(30) Foreign Application Priority Data
Aug. 11, 2010 (KR) 10-2010-0077257

(51) Int. Cl. G01B 11/14

(52) U.S. Cl. 356/616

(57) ABSTRACT

In one example embodiment, position of the alignment unit is acquired using a fiducial mark formed on a moving table, and the moving table is moved such that an alignment mark formed on the workpiece is located within a field of view of the alignment unit to measure the position of the alignment mark. Subsequently, the position and posture of the workpiece are accurately measured based on the position of the alignment unit and the position of the alignment mark measured by the alignment unit.

### CROSS-REFERENCE TO RELATED APPLICATION(S)

This application claims the benefit of Korean Patent Application No. 2010-0077257, filed on Aug. 11, 2010 in the Korean Intellectual Property Office, the disclosure of which is incorporated herein by reference in its entirety.

### BACKGROUND

1. Field

Embodiments relate to a system and method to measure a position and posture of a workpiece, such as a substrate (or a semiconductor wafer), using an alignment unit.

2. Description of the Related Art

Generally, the position and posture of a workpiece, such as a substrate (or a semiconductor wafer) constituting a liquid crystal display (LCD), a plasma display panel (PDP) or a flat panel display (FPD), are measured so as to process, manufacture or inspect the workpiece. To this end, the position and posture of the workpiece are measured using an alignment unit, such as a microscope system.

When the position and posture of the workpiece are measured using the alignment unit, the alignment unit is mounted to coincide with a moving table on which the workpiece is placed in the horizontal and vertical directions so as to accurately measure position and posture information of the workpiece.

In actuality, however, the alignment unit is not always mounted correctly. That is, the alignment unit does not coincide with the moving table in the horizontal and vertical directions. For this reason, it may be desirable to acquire a position of the mounted alignment unit. In particular, when a plurality of alignment units are mounted so as to enable position and posture information of the workpiece to be rapidly measured, it may be desirable to acquire positions of the respective alignment units so as to accurately measure a position and posture of the workpiece.

### SUMMARY

At least one embodiment provides a system and/or method to measure a position and posture of a workpiece, such as a substrate (or a semiconductor wafer), using a plurality of alignment units.

Additional aspects of the embodiments will be set forth in part in the description which follows and, in part, will be obvious from the description, or may be learned by practice of the invention.

In one example embodiment, a method of measuring a position and posture of a workpiece placed on a moving table includes measuring a position of a fiducial mark formed on the moving table using an alignment unit, moving the moving table such that the fiducial mark is located at the center of a field of view of the alignment unit to acquire a position of the alignment unit, acquiring view information of the workpiece using the alignment unit, acquiring a position of an alignment mark formed on the workpiece using a position of the moving table, the position of the alignment unit, and the view information acquired by the alignment unit, and measuring the position and posture of the workpiece using the acquired position of the alignment mark.

The moving table may have two degrees of freedom in which the moving table moves in X- and Y-directions.

The moving table may have three degrees of freedom in which the moving table moves in X-, Y- and Z-directions.

The alignment unit may be one or more in number.

The acquiring the position of the alignment mark may include sequentially processing positions of a plurality of alignment units and view information acquired by the alignment units to acquire the position of the alignment mark formed on the workpiece.

The acquiring the view information of the workpiece may include moving the moving table such that the fiducial mark is located within the field of view of the alignment unit to calculate a mounting error of the alignment unit and measuring the position of the fiducial mark with respect to a coordinate system of a stage using the alignment unit having the mounting error to acquire the view information of the workpiece. The moving table is supported by the stage.

The acquiring the position of the alignment unit may include acquiring the position of the moving table using a feedback signal of a stage when the position of the fiducial mark is located at the center of the field of view of the alignment unit to acquire the position of the alignment unit. The moving table is supported by the stage.

The acquiring the position of the alignment mark may include acquiring position coordinates of the alignment mark formed on the workpiece using the position of the moving table, the position of the alignment unit, and the view information acquired by the alignment unit.

The measuring the position and posture of the workpiece may include acquiring two or more position coordinates of the alignment mark to measure the position and posture of the workpiece.

In accordance with another embodiment, a measurement system includes a moving table configured to move a workpiece, an alignment unit configured to measure a position of a fiducial mark formed on the moving table, and a controller. The controller is configured to move the moving table such that the fiducial mark is located at the center of a field of view of the alignment unit so as to acquire a position of the alignment unit, configured to acquire view information of the workpiece using the alignment unit, configured to acquire a position of an alignment mark formed on the workpiece using the position of the alignment unit and the view information acquired by the alignment unit, and configured to measure a position and posture of the workpiece using the acquired position of the alignment mark.

The alignment unit may include a scope to measure position coordinates of the fiducial mark.

The controller may be configured to move the moving table such that the fiducial mark is located within the field of view of the alignment unit to calculate a mounting error of the alignment unit, and may be configured to measure the position of the fiducial mark with respect to a coordinate system for a stage using the alignment unit having the mounting error to acquire the view information of the workpiece. The moving table is supported by the stage.

The controller may be configured to acquire the position of the moving table using a feedback signal of a stage when the position of the fiducial mark is located at the center of the field of view of the alignment unit to acquire the position of the alignment unit. The moving table is supported by the stage.

The controller may be configured to acquire position coordinates of the alignment mark formed on the workpiece using the position of the moving table, the position of the alignment unit, and the view information acquired by the alignment unit.

The controller may be configured to acquire two or more position coordinates of the alignment mark to measure the position and posture of the workpiece.

### BRIEF DESCRIPTION OF THE DRAWINGS

These and/or other aspects of the embodiments will become apparent and more readily appreciated from the following description of the embodiments, taken in conjunction with the accompanying drawings of which:

FIG. 1 is an overall construction view of a measurement system according to an embodiment;

FIG. 2 is an operation conceptual view of the measurement system according to an embodiment;

FIG. 3 is a control construction view of the measurement system according to an embodiment;

FIG. 4 is a first view illustrating a mark position measured by a k-th alignment unit mounted in the measurement system according to an embodiment;

FIG. 5 is a second view illustrating a mark position measured by the k-th alignment unit mounted in the measurement system according to an embodiment;

FIG. 6 is a view illustrating a process of calculating an alignment unit mounting error using a fiducial mark in the measurement system according to an embodiment;

FIG. 7 is a view illustrating a process of acquiring positions of alignment units using a fiducial mark in the measurement system according to an embodiment; and

FIG. 8 is a view illustrating a process of acquiring positions of alignment marks formed on a workpiece using a plurality of alignment units in the measurement system according to an embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

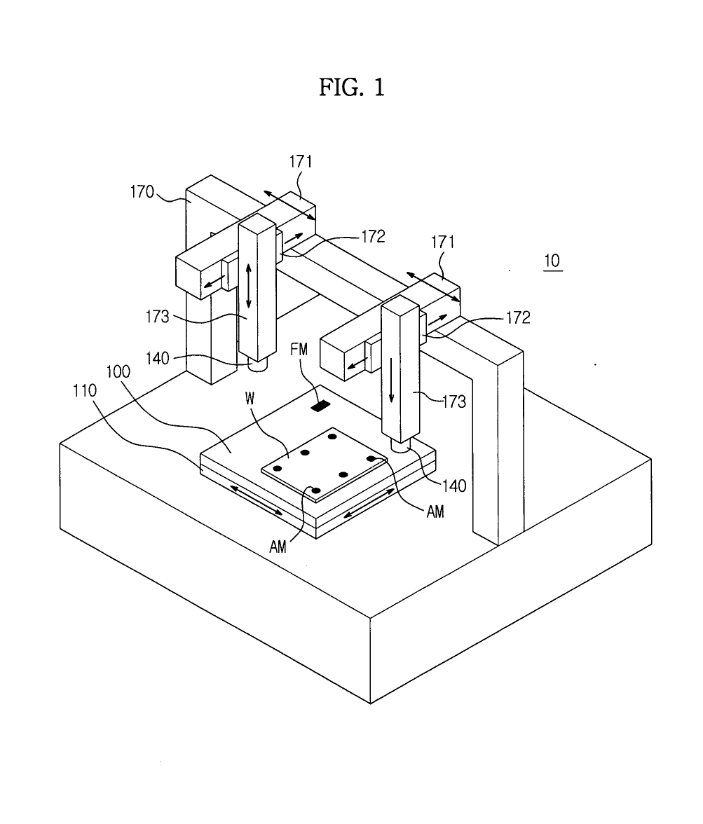

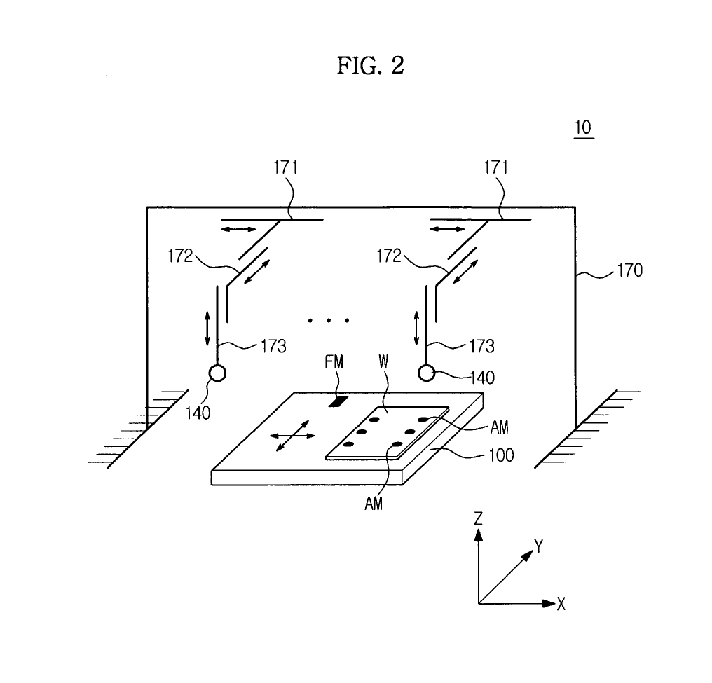

FIG. 1 is an overall construction view of a measurement system 10 according to an embodiment, and FIG. 2 is an operation conceptual view of the measurement system 10 according to the embodiment.

Referring to FIGS. 1 and 2, the measurement system 10 includes a moving table 100 on which a workpiece (a sample, such as a wafer or glass, on which a desired pattern is to be formed) W is placed and a plurality of alignment units 140 mounted above the moving table 100 to measure a position and posture of the workpiece W placed on the moving table 100. The alignment units 140 are mounted to a gantry 170 such that the alignment units 140 move in X-, Y- and Z-directions. The alignment units 140 have three degrees of freedom (X, Y, Z), which is the most common configuration. The degrees of freedom may be restricted. For example, the alignment units 140 may have a degree of freedom in the X-, Y- or Z-direction.

Guide bar type moving members 171, 172 and 173 are mounted to the gantry 170 such that the moving members 171, 172 and 173 move in the X-, Y- or Z-direction. The alignment units 140 are coupled to the moving members 171, 172 and 173 such that the alignment units 140 are moved in the X-, Y- or Z-direction.

Each alignment unit 140 has three degrees of freedom (X, Y, Z) in which each alignment unit 140 moves in the X-, Y- and Z-directions according to the movements of the moving members 171, 172 and 173. The moving table 100, on which the workpiece W is placed, has two degrees of freedom (X, Y) in which the moving table 100 moves in the X- and Y-directions according to the movement of a stage 110.

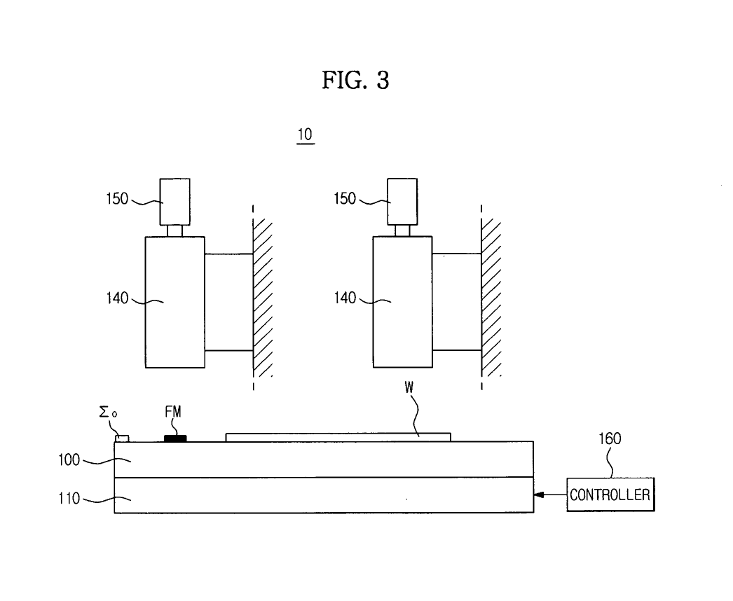

FIG. 3 is a control construction view of the measurement system 10 according to an embodiment.

Referring to FIG. 3, the measurement system 10 includes a stage 110, a plurality of alignment units 140, mark capturing units 150, and a controller 160.

The stage 110 is a device to move the moving table 100, on which the workpiece W is placed, in the X- and Y-directions. The stage 110 moves the moving table 100 according to an instruction from the controller 160 such that a fiducial mark FM formed on the moving table 100 or an alignment mark AM formed on the workpiece W is located within a field of view F.O.V of each alignment unit 140.

The alignment units 140 may be alignment scope units (ASU) provided above the stage 110 to measure the position of the fiducial mark FM formed on the moving table 100 and the position of the alignment mark AM formed on the workpiece W.

The mark capturing units 150 are provided above the respective the alignment units 140 to capture the fiducial mark FM formed on the moving table 100 and the alignment mark AM formed on the workpiece W and transmit the captured images to the controller 160. The captured images may be transmitted wirelessly or by wireline to the controller 160. At this time, the movement of the stage 110 is controlled according to an instruction from the controller 160 until the fiducial mark FM and the alignment mark AM are captured by the mark capturing units 150.

The controller 160 acquires positions of the respective alignment units 140 using the fiducial mark FM formed on the moving table 100 and moves the moving table 100 such that the alignment mark AM formed on the workpiece W is located within a field of view F.O.V of each alignment unit 140 so as to measure a position of the alignment mark AM through each alignment unit 140. Subsequently, a position and posture of the workpiece W are measured based on the position of each alignment unit 140 and the position of the alignment mark AM measured by each alignment unit 140.

Hereinafter, a method of measuring a position and posture of the workpiece W in the measurement system 10 in which the alignment units 140 are mounted will be described.

Before measuring the position and posture of the workpiece W, the position of the fiducial mark FM and the position of each alignment unit 140 based on a mounting error of each alignment unit 140 are acquired.

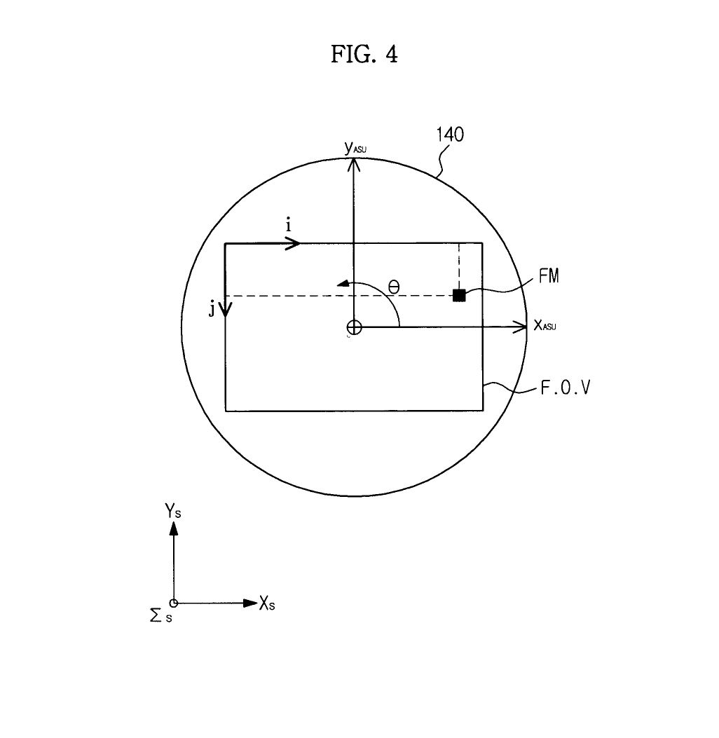

First, a method of acquiring the position of the fiducial mark FM based on the mounting error of each alignment unit 140 will be described with reference to FIGS. 4 to 6.

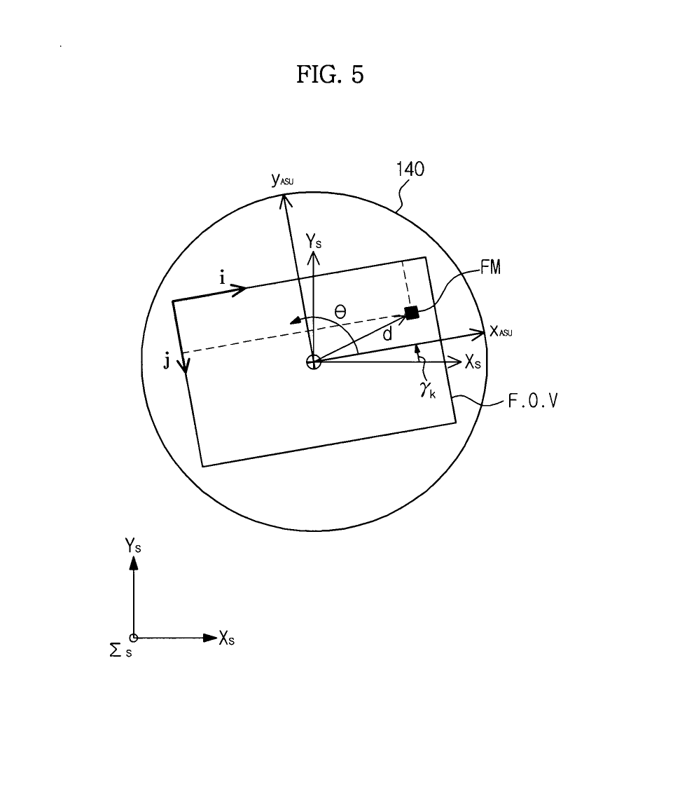

FIG. 4 is a first view illustrating a mark position measured by a k-th alignment unit mounted in the measurement system according to an embodiment, and FIG. 5 is a second view illustrating a mark position measured by the k-th alignment unit mounted in the measurement system according to an embodiment.

Referring to FIGS. 4 and 5, a fiducial mark FM formed on the moving table 100 within a field of view F.O.V of a k-th alignment unit 140 is measured. Physical quantities defined to measure the fiducial mark FM are as follows.

Σ_{S}(X_{S}, γ_{S}) is a body fixed coordinate system of the stage 110 (hereinafter, referred to as a stage coordinate system).

Σ_{ASU}(Σ_{V}) is a body fixed coordinate system of the k-th alignment unit 140 (hereinafter, referred to as a view coordinate system).

Where, k=0, 1, 2 . . . .

FIG. 4 shows that the k-th alignment unit 140 is ideally mounted. The k-th alignment unit 140 coincides in posture with the stage coordinate system Σ_{S}. That is, the mounting error γₖ of the alignment unit 140 is 0.

FIG. 5 shows that the k-th alignment unit 140 is generally mounted. The k-th alignment unit 140 is assembled or mounted at an angle having a mounting error γₖ with respect to the stage coordinate system Σ_{S}.

Generally, each alignment unit 140 is not mounted so as to coincide in posture with the stage coordinate system Σ_{S} as shown in FIG. 4 but at an angle having a mounting error γₖ with respect to the stage coordinate system Σ_{S} as shown in FIG. 5.

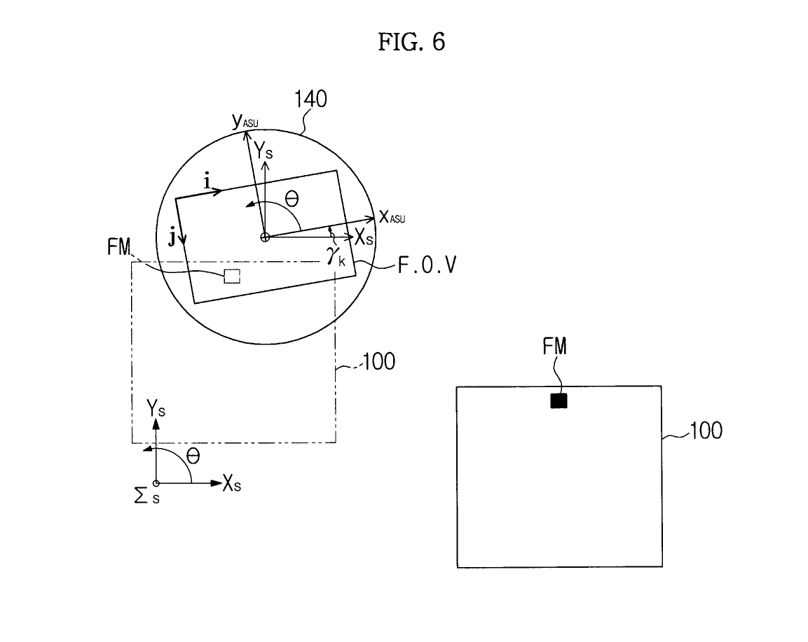

Due to the mounting error γₖ, the position and posture of the workpiece W placed on the moving table 100 may not be accurately measured by each alignment unit 140. For this reason, a mounting error γₖ generated upon mounting of the k-th alignment unit 140 is calculated first, which will be described with reference to FIG. 6.

FIG. 6 is a view illustrating a process of calculating an alignment unit mounting error using a fiducial mark in the measurement system according to an embodiment of the present invention

It is assumed that the alignment unit of FIG. 6 is a k-th alignment unit 140.

A mounting error γₖ of the k-th alignment unit 140 is calculated while the moving table 100 is moved such that a fiducial mark FM formed on the moving table 100 is located within a field of view F.O.V of the k-th alignment unit 140.

The mounting error γₖ may be explained as unit scale factors (Sᵢ, Sⱼ) with respect to directions (i, j) in the field of view F.O.V acquired by the k-th alignment unit 140.

When the mounting error γₖ is 0, which is ideal, a position ^{AUSk}d of the fiducial mark FM on the stage coordinate system Σ_{S} measured by the k-th alignment unit 140 is defined as represented by Equation 1 (see FIG. 4).

$${}^{{ASU}_{k}} d = [ \begin{matrix}{x}_{ASU} \\ {y}_{ASU}\end{matrix} ] , \{ \begin{matrix}{x}_{ASU} ≡ {s}_{i} \cdot ( i - \frac{I}{2} ) \\ {y}_{ASU} ≡ - {s}_{j} \cdot ( j - \frac{J}{2} )\end{matrix} \qquad [ Equation 1 ]$$

In Equation 1, i indicates a pixel index of 0 to I, j indicates a pixel index of 0 to J, Sᵢ indicates a scale vector (nm/pixel) in the i direction, and Sⱼ indicates a scale vector (nm/pixel) in the j direction.

When the mounting error γₖ is not 0, which is general, a position of the fiducial mark FM on the stage coordinate system Σ_{S} measured by the k-th alignment unit 140, i.e., view information ^{S}d acquired by the k-th alignment unit 140, may be defined as represented by Equation 2 (see FIG. 5).

^{S}d=R(γₖ)·^{ASUk}d [Equation 2]

In Equation 2, γₖ is a mounting error of the k-th alignment unit 140, and

$$R ( {γ}_{k} ) = [ \begin{matrix}cos {γ}_{k} & - sin {γ}_{k} \\ sin {γ}_{k} & cos {γ}_{k}\end{matrix} ]$$

Generally, the respective alignment units 140 are mounted in a state in which each of the alignment units 140 has a mounting error γ.

In this embodiment, it is assumed that the view information acquired by the k-th alignment unit 140 has the same direction as an intuitional view from above for convenience. In a case in which the direction of an image is mirrored through an optical device, such as a beam splitter or a mirror, symbols + and − are added in consideration of the directionality.

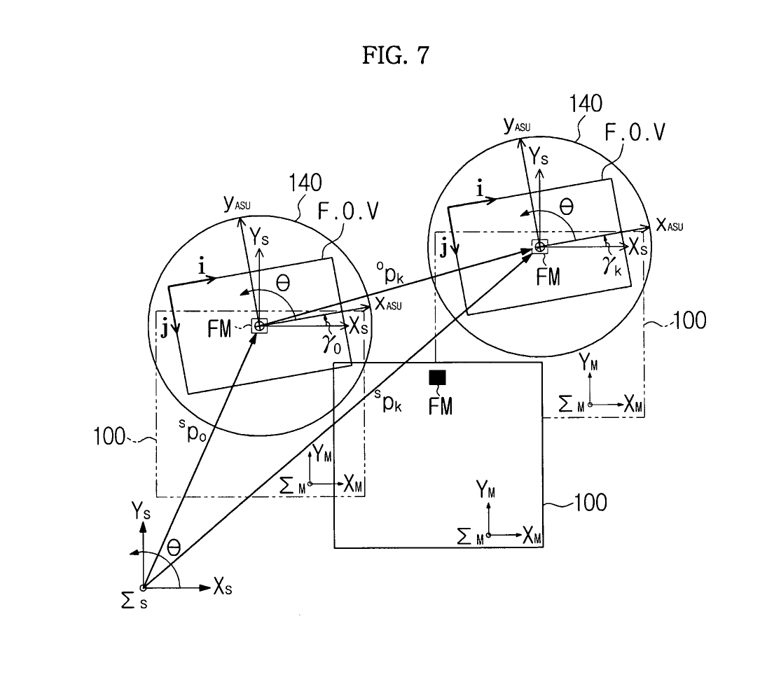

Subsequently, a method of acquiring positions of the alignment units 140 mounted having mounting errors γ will be described with reference to FIG. 7.

FIG. 7 is a view illustrating a process of acquiring positions of alignment units using a fiducial mark in the measurement system according to an embodiment of the present invention.

Referring to FIG. 7, a 0-th alignment unit 140 and a k-th alignment unit 140 are used, and it is assumed that the 0-th alignment unit 140 and the k-th alignment unit 140 have mounting errors γ₀ and γₖ, respectively.

First, the moving table 100 is moved such that the fiducial mark FM formed on the moving table 100 is located within a field of view F.O.V of the k-th alignment unit 140. When the fiducial mark FM is located at the center of the field of view F.O.V of the k-th alignment unit 140, the position of the moving table 100 is acquired through a feedback signal of the stage 110, thereby acquiring a center position ^{S}Pₖ of the k-th alignment unit 140 on the stage coordinate system Σ_{S}.

A center position ^{S}P₀ of the 0-th alignment unit 140 is acquired in the same manner as the above.

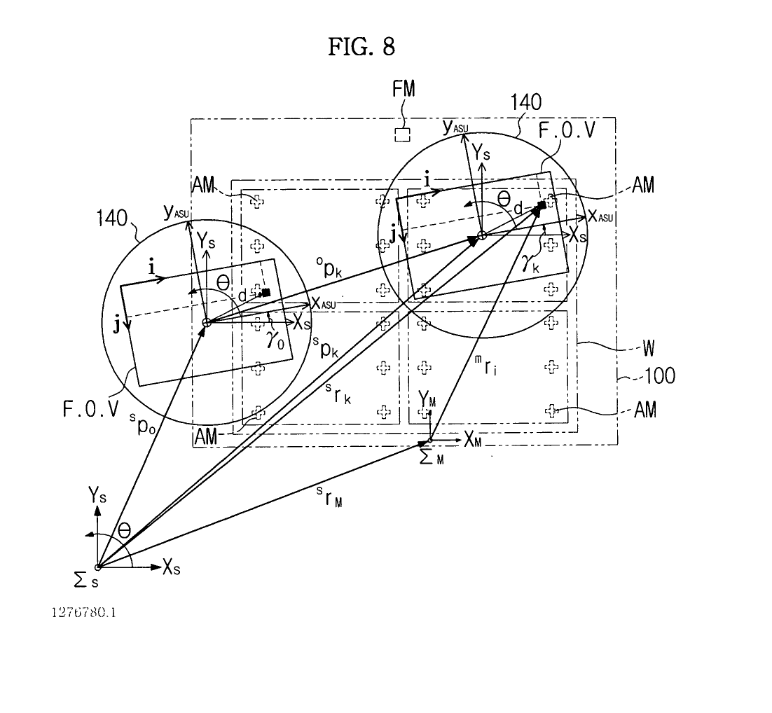

When the position Sd of the fiducial mark FM based on the mounting error γₖ of the k-th alignment unit 140 and the center position ^{S}Pₖ of the k-th alignment unit 140 are acquired, the position of the alignment mark AM formed on the workpiece is acquired using the k-th alignment unit 140, which will be described with reference to FIG. 8.

FIG. 8 is a view illustrating a process of acquiring positions of alignment marks formed on a workpiece using a plurality of alignment units in the measurement system according to an embodiment.

A position ^{S}rₖ of the alignment mark AM measured by the k-th alignment unit 140 on the stage coordinate system Σ_{S} is defined as represented by Equation 3.

$$\begin{matrix}{}_{}^{S}{r}{}_{k}^{} = {}_{}^{S}{p}{}_{k}^{} + R ( {γ}_{k} ) \cdot {}^{ASUk} d \\ = ( {}_{}^{S}{p}{}_{0}^{} + {}_{}^{0}{p}{}_{k}^{} ) + R ( {γ}_{k} ) \cdot {}^{ASUk} d\end{matrix} \qquad [ Equation 3 ]$$

In Equation 3, ^{S}Pₖ of is the center position of the k-th alignment unit 140 on the stage coordinate system Σ_{S}, which is already known through the discussion of FIG. 7 above.

A position ^{S}rᵢₖ of an i-th alignment mark AM measured by the k-th alignment unit 140 on the stage coordinate system Σ_{S} using Equation 3 may also be acquired as represented by Equation 4.

$$\begin{matrix}{}_{}^{S}{r}{}_{ik}^{} = {}_{}^{S}{p}{}_{k}^{} + R ( {γ}_{k} ) \cdot {}_{}^{ASUk}{d}{}_{i}^{} \\ = ( {}^{S} {p}_{0} + {}_{}^{0}{p}{}_{k}^{} ) + R ( {γ}_{k} ) \cdot {}_{}^{ASUk}{d}{}_{i}^{}\end{matrix} \qquad [ Equation 4 ]$$

In Equation 4, k is 0, 1, 2 . . . (alignment unit 140), and i is 1, 2, 3 . . . (alignment mark AM).

The position and posture of the workpiece are measured using the position ^{S}rᵢₖ of the i-th alignment mark AM measured by the k-th alignment unit 140 on the stage coordinate system Σ_{S} acquired by Equation 4.

To this end, physical quantities of Σ_{O} and Σ_{M} are defined first.

Σ_{O}(X_{O}, γ_{O}) is a fiducial coordinate system in which the position and posture of the workpiece W placed on the moving table 100 are acquired. Σ_{O}(X_{O}, γ_{O}) is provided on the moving table 100.

Σ_{M}(X_{M}, γ_{M}) is a body fixed coordinate system of the moving table 100 (hereinafter, referred to as a moving coordinate system). The center of Σ_{M} is an arbitrary point on the moving table 100. The center of Σ_{M} may be a significant design position or a fiducial mark FM.

Therefore, the position ^{S}rᵢₖ of the i-th alignment mark AM measured by the k-th alignment unit 140 on the stage coordinate system Σ_{S} is a position ^{S}rᵢₖ of the i-th alignment mark AM on the moving coordinate system Σ_{M} as represented by Equation 5.

$$\begin{matrix}{}_{}^{S}{r}{}_{ik}^{} = {}_{}^{S}{p}{}_{k}^{} + R ( {γ}_{k} ) \cdot {}_{}^{ASUk}{d}{}_{i}^{} \\ = ( {}_{}^{S}{p}{}_{0}^{} + {}_{}^{0}{p}{}_{k}^{} ) + R ( {γ}_{k} ) \cdot {}_{}^{ASUk}{d}{}_{i}^{} \\ = {}_{}^{S}{r}{}_{M}^{} + {}_{}^{M}{r}{}_{i}^{}\end{matrix} \qquad [ Equation 5 ]$$

In Equation 5, ^{S}r_{M} is an arbitrary point on the moving table with respect to the stage coordinate system Σ_{S}. ^{S}r_{M} is measured through a feedback signal of the stage 110. ^{M}rᵢ is the position of an i-th alignment mark AM measured on the moving coordinate system Σ_{M}.

Therefore, the position ^{M}rᵢ of the i-th alignment mark AM measured on the moving coordinate system Σ_{M} is defined as represented by Equation 6.

^{M}rᵢ=−^{S}r_{M}+(^{S}P_{O}+^{O}Pₖ)+R(γₖ)·^{ASUk}d [Equation 6]

In conclusion, a position ^{O}rᵢ of the i-th alignment mark AM on the moving coordinate system Σ_{M} defined using the fiducial coordinate system Σ_{O} through Equation 6 is acquired as represented by Equation 7.

$$\begin{matrix}{}_{}^{O}{r}{}_{i}^{} ≡ {}_{}^{M}{r}{}_{i}^{} \\ = - {{}_{}^{S}{r}{}_{M}^{}}_{.} + {( {}_{}^{S}{p}{}_{0}^{} + {}_{}^{0}{p}{}_{k}^{} )}_{.} + {R ( {γ}_{k} ) \cdot {}_{}^{ASUk}{d}{}_{i}^{}}_{.}\end{matrix} \qquad [ Equation 7 ]$$

In Equation 7, ^{S}r_{M} is a position of the moving table 100 acquired through a feedback signal of the stage 110, (^{S}P₀+^{O}Pₖ)) is a position ^{S}Pₖ of each alignment unit 140 (for example, the k-th alignment unit), and R(γₖ). ^{ASUk}dᵢ is view information ^{S}d acquired by each alignment unit 140 (for example, the k-th alignment unit).

A position ^{O}rᵢ of the i-th alignment mark AM formed on the workpiece W is finally acquired based on the position ^{S}r_{M} of the moving table 100, the position ^{S}Pₖ of each alignment unit 140 (for example, the k-th alignment unit), and the view information ^{S}d acquired by each alignment unit 140 (for example, the k-th alignment unit) as represented by Equation 7.

In ^{O}rᵢ, i=1, 2 . . . (alignment mark AM).

Two positions ^{O}r_{i=1,2} of the alignment mark AM formed on the workpiece W are acquired to measure a position and posture of the workpiece W. Meanwhile, more than two positions ^{O}r_{i=1,2} . . . of the alignment mark AM formed on the workpiece W may be acquired to measure a position and posture of the workpiece W using a least square method.

In this embodiment, the position ^{O}rᵢ of the alignment mark AM formed on the workpiece W is acquired using the k-th alignment unit 140. However, embodiments are not limited thereto. For example, the position ^{O}rᵢ of the alignment mark AM formed on the workpiece W may be acquired using a plurality of alignment units 140. In this case, positions ^{S}P_{k=0, 1,2 . . .} of the alignment units 140 may be previously determined as described above with respect to FIG. 7. Also, view information ^{S}d acquired by the respective alignment units 140 may be processed in parallel (the view information may be rapidly processed by the respective alignment units in sequence, which may be considered a form of semi-parallel processing). When multiple alignment units 140 are used, the position ^{O}r of the alignment mark AM formed on the workpiece W is more rapidly acquired, thereby more rapidly measuring the position and posture of the workpiece W.

Also, in this embodiment, the alignment units 140 are fixed and the moving table 100 is moved to measure the alignment mark AM formed on the workpiece W, thereby measuring the position and posture of the workpiece W. However, embodiments are not limited thereto. For example, the moving table 100 may be fixed and the alignment units 140 may be moved to measure the alignment mark AM formed on the workpiece W, thereby measuring the position and posture of the workpiece W. Alternatively, the moving table 100 and the alignment units 140 may be moved to measure the alignment mark AM formed on the workpiece W, thereby measuring the position and posture of the workpiece W.

As is apparent from the above description, the position and posture of a workpiece, such as a substrate (or a semiconductor wafer), are accurately measured using a plurality of alignment units within a short time. Consequently, the measurement system using the alignment units and the position measuring method are variously utilized in processing, manufacture or inspection of the workpiece.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of measuring a position and posture of a workpiece placed on a moving table, comprising:
measuring a position of a fiducial mark formed on the moving table using an alignment unit;
moving the moving table such that the fiducial mark is located at a center of a field of view of the alignment unit to acquire a position of the alignment unit;
acquiring view information of the workpiece using the alignment unit;
acquiring a position of an alignment mark formed on the workpiece using a position of the moving table, the position of the alignment unit, and the view information acquired by the alignment unit; and
measuring the position and posture of the workpiece using the acquired position of the alignment mark.

2. The method according to claim 1, wherein the moving table has two degrees of freedom in which the moving table moves in X- and Y-directions.

3. The method according to claim 1, wherein the moving table has three degrees of freedom in which the moving table moves in X-, Y- and Z-directions.

4. The method according to claim 3, wherein the alignment unit is one or more in number.

5. The method according to claim 4, wherein the acquiring a position of the alignment mark comprises sequentially processing positions of a plurality of alignment units and view information acquired by the alignment units to acquire the position of the alignment mark formed on the workpiece.

6. The method according to claim 1, wherein the acquiring view information of the workpiece comprises:
moving the moving table such that the fiducial mark is located within the field of view of the alignment unit to calculate a mounting error of the alignment unit; and
measuring the position of the fiducial mark with respect to a coordinate system for a stage using the alignment unit having the mounting error to acquire the view information of the workpiece, the moving table being supported by the stage.

7. The method according to claim 1, wherein the acquiring a position of the alignment unit comprises acquiring the position of the moving table using a feedback signal of a stage when the position of the fiducial mark is located at the center of the field of view of the alignment unit, the moving table being supported by the stage.

8. The method according to claim 6, wherein the acquiring a position of the alignment mark comprises acquiring position coordinates of the alignment mark formed on the workpiece using the position of the moving table, the position of the alignment unit, and the view information acquired by the alignment unit.

9. The method according to claim 8, wherein the measuring the position and posture of the workpiece comprises acquiring two or more position coordinates of the alignment mark to measure the position and posture of the workpiece.

10. The method according to claim 7, wherein the acquiring a position of the alignment mark comprises acquiring position coordinates of the alignment mark formed on the workpiece using the position of the moving table, the position of the alignment unit, and the view information acquired by the alignment unit.

11. The method according to claim 10, wherein the measuring the position and posture of the workpiece comprises acquiring two or more position coordinates of the alignment mark to measure the position and posture of the workpiece.

12. A measurement system comprising:
a moving table configured to move a workpiece;
an alignment unit configured to measure a position of a fiducial mark formed on the moving table; and
a controller configured to move the moving table such that the fiducial mark is located at a center of a field of view of the alignment unit so as to acquire a position of the alignment unit, configured to acquire view information of the workpiece using the alignment unit, configured to acquire a position of an alignment mark formed on the workpiece using the position of the alignment unit and the view information acquired by the alignment unit, and configured to measure a position and posture of the workpiece using the acquired position of the alignment mark.

13. The measurement system according to claim 12, wherein the moving table has two degrees of freedom in which the moving table moves in X- and Y-directions.

14. The measurement system according to claim 12, wherein the moving table has three degrees of freedom in which the moving table moves in X-, Y- and Z-directions.

15. The measurement system according to claim 12, wherein the alignment unit is one or more in number.

16. The measurement system according to claim 12, wherein the alignment unit comprises a scope to measure position coordinates of the fiducial mark.

17. The measurement system according to claim 12, wherein the controller is configured to move the moving table such that the fiducial mark is located within the field of view of the alignment unit to calculate a mounting error of the alignment unit, and is configured to measure the position of the fiducial mark with respect to a coordinate system for a stage using the alignment unit having the mounting error to acquire the view information of the workpiece, the stage supporting the moving table.

18. The measurement system according to claim 12, wherein the controller is configured to acquire the position of the moving table using a feedback signal of a stage when the position of the fiducial mark is located at the center of the field of view of the alignment unit to acquire the position of the alignment unit, the stage supporting the moving table.

19. The measurement system according to claim 17, wherein the controller is configured to acquire position coordinates of the alignment mark formed on the workpiece using the position of the moving table, the position of the alignment unit, and the view information acquired by the alignment unit.

20. The measurement system according to claim 19, wherein the controller is configured to acquire two or more position coordinates of the alignment mark to measure the position and posture of the workpiece.

21. The measurement system according to claim 18, wherein the controller is configured to acquire position coordinates of the alignment mark formed on the workpiece using the position of the moving table, the position of the alignment unit, and the view information acquired by the alignment unit.

22. The measurement system according to claim 21, wherein the controller is configured to acquire two or more position coordinates of the alignment mark to measure the position and posture of the workpiece.
